(19) United States
(12) Patent Application Publication
(10) Pub. No.: US 2014/0263978 A1
(43) Pub. Date: Sep. 18, 2014

(54) SELF-CALIBRATION METHOD FOR A PHOTOELECTRIC LIQUID LEVEL SWITCH AND APPARATUS USING THE SAME

(71) Applicant: FINETEK CO., LTD., New Taipei City (TW)

(72) Inventors: BO-YI WU, NEW TAIPEI CITY (TW); CHI-FAN LIAO, NEW TAIPEI CITY (TW); CHIU-HSING LIU, NEW TAIPEI CITY (TW); CHAO-KAI CHENG, NEW TAIPEI CITY (TW)

(73) Assignee: FINETEK CO., LTD., NEW TAIPEI CITY (TW)

(21) Appl. No.: 13/799,595

(22) Filed: Mar. 13, 2013

(51) Int. Cl. H01H 35/18

(52) U.S. Cl. CPC H01H 35/18
USPC 250/214 SW

(57) ABSTRACT

The invention relates to a self-calibration method for a photoelectric liquid level switch and apparatus using the same. The apparatus has a control module, a light emitting module and a light sensing module. The light emitting module emits a light beam into a container. The light sensing module then detects a reflected light beam. The control module acquires two values respectively standing for a first liquid level status and a second liquid level status. When a default threshold value is beyond a range between the two values, the control module calculates a new threshold value in the range between the two values. The control module then replaces the default threshold value with the new threshold value. The threshold value is adjustable for any kind of liquid.

### BACKGROUND OF THE INVENTION

1. Field of the Invention

The present invention relates to a liquid level detecting apparatus, and more particularly to a self-calibration method for a photoelectric liquid level switch and an apparatus using the same.

2. Description of Related Art

A photoelectric liquid level switch is widely used in industries, such as petrochemical industry, food industry, animal feed industry, steel industry, cement industry, etc., which are all industries that demand huge storage of raw materials. The photoelectric liquid level switch is mounted on a wall of a container and is electrically connected to a control system. The control system monitors a present liquid storage of the container by using the photoelectric liquid level switch.

A conventional photoelectric liquid level switch has a light emitter and an optical sensor. The light emitter emits a light beam toward the liquid stored in the container. The light beam is then reflected by the liquid and the optical sensor detects the reflected light beam. The photoelectric liquid level switch converts an intensity of the reflected light beam to a measurement value. The photoelectric liquid level switch is preset with a default threshold value. The control system compares the measurement value with the default threshold value to determine liquid level of the liquid.

For example, with reference to FIG. 10, the default threshold value of the photoelectric liquid level switch is 2.5. When the measurement value is higher than 2.5, i.e. the measurement value is 5 in FIG. 10, the liquid level is under a position of the photoelectric liquid level switch. A status of the present liquid level can be defined as an empty elevation. On the contrary, when the measurement value is lower than 2.5, i.e. the measurement value is 0 in FIG. 10, the liquid level is above the position of the photoelectric liquid level switch. The status of the present liquid level can be defined as a full elevation.

However, an intensity of the light beam emitted from the light emitter, a sensitivity of the optical sensor, and the default threshold value are all fixed and are only applicable for a certain kind of liquid, or liquid with stable characteristics, or a clear liquid. One default threshold value is applicable for only one liquid. As a result, the conventional photoelectric liquid level switch cannot detect the liquid level of unknown liquid or turbid liquid.

### SUMMARY OF THE INVENTION

An objective of the invention is to provide a self-calibration apparatus for a photoelectric liquid level switch. The apparatus of the invention has a variable threshold value. The threshold value changes with different kinds of liquids, such that the apparatus of the invention can detect the liquid level for various kinds of liquids.

The self-calibration apparatus of the invention comprises:

a light emitting module generating a light beam;

a light sensing module receiving a reflection of the light beam and correspondingly generating a detection signal; and

a control module electrically connected to the light emitting module and the light sensing module to control an intensity of the light beam and to control a sensitivity of the light sensing module, having a self-calibration unit and storing a default threshold value; wherein

the self-calibration unit acquires a first value standing for a first liquid level status and a second value standing for a second liquid level status;

when the default threshold value is beyond a range between the first value and the second value, the self-calibration unit replaces the default threshold value with a new threshold value in the range between the first value and the second value.

Another objective of the invention is to provide a self-calibration method for a photoelectric liquid level switch. The method comprises the steps of:

acquiring a first value standing for a first liquid level status, wherein the first value is a ratio of a first light emitting intensity to a first light receiving intensity;

acquiring a second value standing for a second liquid level status, wherein the second value is a ratio of a second light emitting intensity to a second light receiving intensity;

determining whether a default threshold value is in a range between the first value and the second value;

calculating a new threshold value in the range when the default threshold value is beyond the range; and

replacing the default threshold value with the new threshold value.

The control module controls or adjusts the intensity of the light beam emitted from the light emitting module and the sensitivity of the light sensing module to detect the liquid level of the liquid stored in a container. The control module acquires the values of the first liquid level status and the second liquid level status. The self-calibration unit then calculates a new threshold value and automatically replaces the default threshold value with the new threshold value. Hence, the apparatus of the invention can use a correct threshold value to detect the liquid level for any liquid.

### BRIEF DESCRIPTION OF THE DRAWINGS

FIG. 1 is a circuit block diagram of a first embodiment of the self-calibration apparatus of the invention;

FIG. 2A is a circuit diagram of the light emitting module;

FIG. 2B is a circuit diagram of another embodiment of the light emitting module;

FIG. 3 is a flow chart for adjusting the threshold value;

FIG. 4 is a flow chart of the method of the invention;

FIG. 5A is a chart showing that the default threshold value is not between the first value and the second value;

FIG. 5B is a chart showing that the new threshold value is between the first value and the second value;

FIG. 6 is a circuit block diagram of an intensity adjustor connected between the light emitting unit and the control module;

FIG. 7A is a wave diagram of the PWM signal with a duty cycle of 50%;

FIG. 7B is a wave diagram of the PWM signal with a duty cycle of 75%;

FIG. 7C is a wave diagram of the PWM signal with a duty cycle of 100%;

FIG. 8 is a circuit block diagram of adjustable apertures mounted in the light emitting module and the light sensing module;

FIGS. 9A-9C are plan views of the adjustable aperture; and

FIG. 10 is a chart representing the relationship between the default threshold value, the first value and the second value.

### DETAILED DESCRIPTION OF THE PREFERRED EMBODIMENT

With reference to FIG. 1, a self-calibration apparatus of a first embodiment of the invention comprises a control module 10, a light emitting module 20 and a light sensing module 30. The light emitting module 20 and the light sensing module 30 are mounted on a wall of a container 40 and are adjacent to each other. The container 40 is adapted to store liquid.

The control module 10 comprises a self-calibration unit 11 and stores a default threshold value 12. The default threshold value 12 is variable. The self-calibration unit 11 is used to replace the default threshold value 12 with a new threshold value according to the liquid stored in the container.

The light emitting module 20 is electronically connected to the control module 10. With reference to FIG. 2A, the light emitting module 20 comprises a light emitting unit 21 and an intensity control unit 22. The light emitting unit 21 is electrically connected to the intensity control unit 22 in series and is connected to a DC power supply (V+) through the intensity control unit 22. The control module 10 adjusts the intensity of the light beam of the light emitting unit 21 by controlling a voltage across the intensity control unit 22. In this embodiment, the light emitting unit 21 is an LED (light emitting diode) (D1). The intensity control unit 22 can be a variable resistor (R1) or a voltage adjuster.

The light sensing module 30 is electronically connected to the control module 10 and comprises a light receiver 31 and a sensitivity adjustor 32. The light receiver 31 is electronically connected to the sensitivity adjustor 32 in series and is connected to a DC power supply (Vcc) through the sensitivity adjustor 32. The light receiver 31 of the light sensing module 30 detects a reflection of the light beam and generates a detection signal according to an intensity of the reflection. The control module 10 controls the sensitivity adjustor 32 to control a sensitivity of the light receiver 31 to control or adjust the detection signal of the light sensing module 30. The light receiver 31 can be a phototransistor or a photo resistor (cds). With reference to FIG. 2A, the sensitivity adjustor 32 can be a variable resistor (R_{C}) connected to a collector of the light receiver 31. With reference to FIG. 2B, in another embodiment of the light sensing module 30, the sensitivity adjustor 32 can be a variable resistor (R_{E}) connected to an emitter of the light receiver 31.

With reference to FIGS. 3 and 4, the self-calibration unit 11 of the control module 10 executes the following steps to adjust or change the default threshold value.

The self-calibration unit 11 acquires a first value standing for a first liquid level status (STEP 101). The first liquid level status can stand for an empty elevation. The first value is a ratio of the intensity of the light beam generated from the light emitting unit 21 to the intensity of the reflection received by the light receiver 31.

When the container is filled with liquid, the self-calibration unit 11 acquires a second value standing for a second liquid level status (STEP 102). The second liquid level status can stand for a full elevation. The second value is a ratio of the intensity of the light beam generated from the light emitting unit 21 to the intensity of the reflection received by the light receiver 31.

Interchangeably, the first liquid level status can stand for a full elevation and the second liquid level status stands for an empty elevation.

The self-calibration unit 11 determines whether the default threshold value 12 is in a range between the first value and the second value (STEP 103).

When the default threshold value 12 is in the range between the first value and the second value, the self-calibration unit 11 keeps the default threshold value 12 (STEP 104).

When the default threshold value 12 is beyond the range between the first value and the second value, the self-calibration unit 11 calculates a new threshold value and replaces the default threshold value 12 with the new threshold value (STEP 105). The new threshold value is in the range between the first value and the second value. For example, the new threshold value can be an average value of the first value and the second value.

The self-calibration unit 11 calculates the new threshold value in the range between the first value and the second value according to the liquid stored in the container. For example, with reference to FIG. 5A, the default threshold value is 2.5. The first value and the second value are respectively 5 and 3. The default threshold value is beyond the range between the first value and the second value. By executing the steps (101)-(105) as mentioned above, with reference to FIG. 5B, the default threshold value of 2.5 is replaced by a new threshold value of 4 that is an average value of the first value and the second value. The new threshold value is then in the range between the first value and the second value.

With reference to FIGS. 6 and 7A-7C, a second embodiment of the invention is disclosed. The control module 10 outputs a PWM (pulse width modulation) signal to adjust the intensity of the light beam of the light emitting unit 21. The light emitting unit 21 can be directly connected to the control module 10, such that the control module 10 can directly control the light beam of the light emitting unit 21. With reference to FIG. 6, an intensity adjustor 22′ with a PWM control function is connected between the light emitting unit 21 and the control module 10. The intensity adjustor 22′ outputs a PWM signal to activate the light emitting unit 21 and controls a duty cycle of the PWM signal. With reference to FIG. 7A-7C, the duty cycle can be 50%, 75% or 100%.

With reference to FIGS. 8 and 9A-9C, a third embodiment of the invention is disclosed. A first adjustable aperture 50 is disposed in the light emitting module 20 in a light path of the light emitting unit 21 and the light receiver 31. A second adjustable aperture 50′ is disposed in the light sensing module 30 in the light path of the light emitting unit 21 and the light receiver 31. The control module 10 can respectively adjust the adjustable apertures 50, 50′ to change the intensity of the light beam of the light emitting unit 21 and to change the intensity of the reflection received by the light receiver 31.

What is claimed is:

1. A self-calibration apparatus for a photoelectric liquid level switch, the self-calibration apparatus comprising:
a light emitting module generating a light beam;
a light sensing module receiving a reflection of the light beam and correspondingly generating a detection signal; and
a control module electrically connected to the light emitting module and the light sensing module to control an intensity of the light beam and to control a sensitivity of the light sensing module, having a self-calibration unit and storing a default threshold value; wherein
the self-calibration unit acquires a first value standing for a first liquid level status and a second value standing for a second liquid level status;
when the default threshold value is beyond a range between the first value and the second value, the self-calibration unit replaces the default threshold value with a new threshold value in the range between the first value and the second value.

2. The self-calibration apparatus as claimed in claim 1, wherein the light emitting module comprises:
a light emitting unit emitting the light beam; and
an intensity control unit connected to the light emitting unit in series to adjust the intensity of the light beam.

3. The self-calibration apparatus as claimed in claim 2, wherein the light emitting unit is an LED and the intensity control unit is a variable resistor.

4. The self-calibration apparatus as claimed in claim 1, wherein the light sensing module comprises:
a light receiver; and
a sensitivity adjustor connected to the light receiver to adjust the sensitivity of the light receiver.

5. The self-calibration apparatus as claimed in claim 2, wherein the light sensing module comprises:
a light receiver; and
a sensitivity adjustor connected to the light receiver to adjust the sensitivity of the light receiver.

6. The self-calibration apparatus as claimed in claim 3, wherein the light sensing module comprises:
a light receiver; and
a sensitivity adjustor connected to the light receiver to adjust the sensitivity of the light receiver.

7. The self-calibration apparatus as claimed in claim 4, wherein the light receiver is a phototransistor and the sensitivity adjustor is a variable resistor.

8. The self-calibration apparatus as claimed in claim 5, wherein the light receiver is a phototransistor and the sensitivity adjustor is a variable resistor.

9. The self-calibration apparatus as claimed in claim 6, wherein the light receiver is a phototransistor and the sensitivity adjustor is a variable resistor.

10. The self-calibration apparatus as claimed in claim 1, wherein the control module outputs a PWM signal to adjust the intensity of the light beam of the light emitting module.

11. The self-calibration apparatus as claimed in claim 2, wherein the control module outputs a PWM signal to adjust the intensity of the light beam of the light emitting module.

12. The self-calibration apparatus as claimed in claim 3, wherein the control module outputs a PWM signal to adjust the intensity of the light beam of the light emitting module.

13. The self-calibration apparatus as claimed in claim 4, wherein the control module outputs a PWM signal to adjust the intensity of the light beam of the light emitting module.

14. The self-calibration apparatus as claimed in claim 5, wherein the control module outputs a PWM signal to adjust the intensity of the light beam of the light emitting module.

15. The self-calibration apparatus as claimed in claim 6, wherein the control module outputs a PWM signal to adjust the intensity of the light beam of the light emitting module.

16. The self-calibration apparatus as claimed in claim 2, wherein an intensity adjustor connected between the light emitting unit and the control module and has a PWM control function for adjusting the intensity of the light beam of the light emitting unit.

17. The self-calibration apparatus as claimed in claim 3, wherein an intensity adjustor connected between the light emitting unit and the control module and has a PWM control function for adjusting the intensity of the light beam of the light emitting unit.

18. The self-calibration apparatus as claimed in claim 4, wherein an intensity adjustor connected between the light emitting unit and the control module and has a PWM control function for adjusting the intensity of the light beam of the light emitting unit.

19. The self-calibration apparatus as claimed in claim 5, wherein an intensity adjustor connected between the light emitting unit and the control module and has a PWM control function for adjusting the intensity of the light beam of the light emitting unit.

20. The self-calibration apparatus as claimed in claim 6, wherein an intensity adjustor connected between the light emitting unit and the control module and has a PWM control function for adjust the intensity of the light beam of the light emitting unit.

21. The self-calibration apparatus as claimed in claim 1 further comprising:
a first adjustable aperture disposed in the light emitting module in a light path between the light emitting module and the light sensing module, and connected to the control module; and
a second adjustable aperture disposed in the light sensing module in the light path between the light emitting module and the light sensing module and connected to the control module; wherein the control module controls the first adjustable aperture and the second adjustable aperture to adjust the intensity of the light beam of the light emitting module and to adjust the intensity of the reflection of the light beam received by the light sensing module.

22. A self-calibration method for a photoelectric liquid level switch, the method comprising the steps of:
acquiring a first value standing for a first liquid level status, wherein the first value is a ratio of a first light emitting intensity to a first light receiving intensity:
acquiring a second value standing for a second liquid level status, wherein the second value is a ratio of a second light emitting intensity to a second light receiving intensity;
determining whether a default threshold value is in a range between the first value and the second value;
calculating a new threshold value in the range when the default threshold value is beyond the range; and
replacing the default threshold value with the new threshold value.

23. The method as claimed in claim 22, wherein the new threshold value is an average value of the first value and the second value.

24. The method as claimed in claim 22, wherein the first liquid level status stands for an empty elevation and the second liquid level status stands for a full elevation.
